(19) United States
(12) Patent Application Publication
(10) Pub. No.: US 2012/0201648 A1
(43) Pub. Date: Aug. 9, 2012

(54) METHOD AND DEVICE FOR BRINGING AN ELONGATED BODY BELONGING TO A SUBSEA STRUCTURE TO THE SURFACE

(75) Inventor: Leif Salthaug, Mandal (NO)

(73) Assignee: SALCON AS

(21) Appl. No.: 13/364,729

(22) Filed: Feb. 2, 2012

(30) Foreign Application Priority Data
Feb. 8, 2011 (NO) 20110219

(51) Int. Cl. B66F 11/00; B66C 1/42

(52) U.S. Cl. 414/814; 294/67.3; 294/67.31; 294/67.32; 294/67.33

(57) ABSTRACT

An elongated body belonging to a subsea structure may be moved to the surface. A lifting beam may be lowered to the body and then may be pivoted until the lifting beam is substantially parallel to the body. Grippers connected to the lifting beam may rotate to encircle the body and/or connect the body to the lifting beam. After the body has been released from the subsea structure, the body may be turned until the body is in a substantially upright position, and then the lifting beam may move the body through a splash zone to the surface.

This application claims the benefit of Norwegian Patent Application No. 20110219 filed on Feb. 8, 2011 in the Norwegian Industrial Property Office, the entire disclosure of which is incorporated herein by reference.

### BACKGROUND OF THE INVENTION

The present invention generally relates to a method of bringing an elongated body belonging to a subsea structure to the surface. More particularly, the present invention relates to a method of bringing an elongated body belonging to a subsea structure to the surface using a lifting beam. The present invention also relates to a device for practicing the method.

As fixed installations offshore have exceeded their technical/economic service life, they must be removed because of official requirements, among other things. Typically the portions of the structure that are under water are divided into suitable parts for a crane vessel of a substantial size to lift them to the surface and, for example, place the parts on a barge for further transport. Relatively speaking, this method is very time-consuming and expensive because of, among other things, the availability of crane vessels of sufficient lifting capacity being limited.

### SUMMARY OF THE INVENTION

The present invention has for its object to remedy or reduce at least one of the drawbacks of the prior art. The object is achieved in accordance with the present invention through the features which are specified in the description below and in the claims that follow. In an embodiment, a method of bringing an elongated body belonging to a subsea structure to the surface is provided, and the method includes lowering a lifting beam to the body; pivoting the lifting beam until, in the main, it is parallel to the body; gripping the body by means of grippers; after the body has been released from the subsea structure, turning the body until it is in an upright position; and lifting the body through the splash zone to the surface.

Additional features and advantages of the present invention are described in, and will be apparent from, the detailed description of the presently preferred embodiments and from the drawings.

### BRIEF DESCRIPTION OF THE DRAWINGS

FIG. 1 generally illustrates a side view of a lifting beam in accordance with the invention at an elongated body which is to be lifted in an embodiment of the present invention.

FIG. 2 generally illustrates an end view of the lifting beam in which the lifting beam is connected to the body in an embodiment of the present invention.

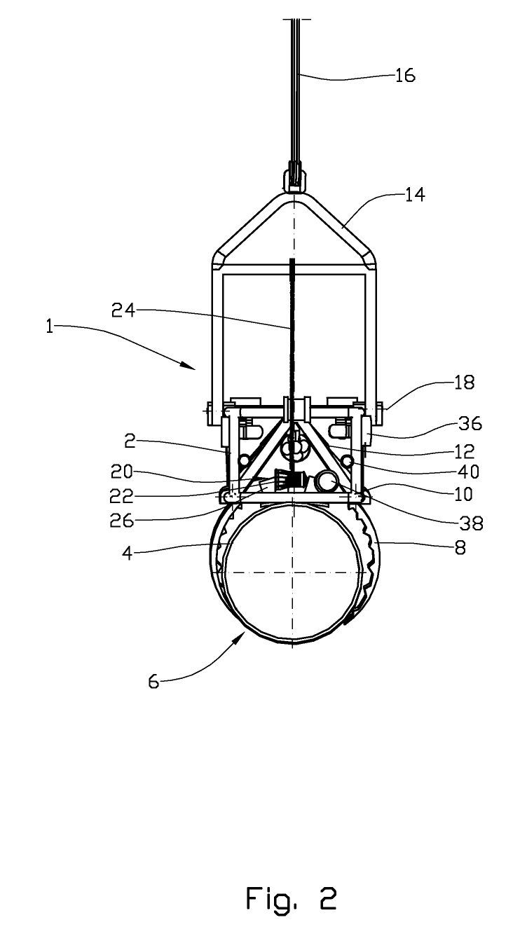

FIG. 3 generally illustrates a side view in which the body has been turned into an upright position and is being lifted through the splash zone in an embodiment of the present invention.

FIG. 4 generally illustrates, on a larger scale, part of a section III-III of FIG. 3 in an embodiment of the present invention.

### DETAILED DESCRIPTION OF THE PREFERRED EMBODIMENTS

The present invention generally relates to a method of bringing an elongated body belonging to a subsea structure to the surface. The method may include lowering a lifting beam to the body; pivoting the lifting beam until, in the main, the lifting beam is parallel to the body; gripping the body by means of grippers; after the body has been released from the subsea structure, turning the body until the body is in an upright position; and lifting the body through the splash zone to the surface.

Typically, the lifting beam is lowered to the body while the grippers are in their open position. The lifting beam is pivoted until it takes a parallel position relative to the body, after which the lifting beam is lowered onto the body or moved in to the body, according to the position of the body. The grippers are moved into their gripping position around the body. After the body has been released from the rest of the subsea structure, the body is turned into an upright position before the body is lifted through the splash zone to the surface.

By turning the body into an upright position, environmental forces, such as wave forces in the splash zone, acting on the body are reduced substantially. The body which may have a transverse dimension of several meters and a length of several tens of meters is exposed to considerable environmental forces if moved through the splash zone in a horizontal position, which exposes the lifting equipment to considerable additional forces. Preferably, the body is then turned into a horizontal position before the body is placed on a barge for further transport, for example. The method may further include locking the body to the lifting beam, at least in the axial direction, using locking pins to prevent the body from sliding when raised into the upright position.

The method may be practiced by using a lifting beam to bring an elongated body belonging to a subsea structure to the surface. The lifting beam may be arranged to be connected to a lifting device, and the lifting beam may include actuator-operated grippers which are movable between an open, free position and a closed, gripping position. The lifting beam may have an actuator-operated lifting connector which may be movable relative to the lifting beam.

The lifting connector and the gripping arms may be at least rotatably or displaceably connected to the lifting beam. The actuators may be constituted by, for example, hydraulic or electric winches, and/or hydraulic cylinders or gears, possibly with pitch racks, which are electrically or hydraulically operated.

The lifting beam may be provided with a locking-pin mover. In a preferred embodiment, the locking-pin mover may be constituted by a cylinder in which a pyrotechnical charge, on detonation, is arranged to drive a locking pin into the body. Alternatively, the locking-pin mover may include some drilling equipment which provides an opening in the body before the locking pin is moved into the body.

The lifting beam may be provided with a thruster in order to be oriented more easily relative to the body, especially during the connecting operation. The lifting beam may be provided with a light source and a camera to facilitate remote control of the lifting beam from the surface. The method and the device in accordance with the invention may enable the use of vessels of relatively modest lifting capacities for the removal of subsea structures. As cutting techniques, for example by means of diamond wire or water cutting, have been developed, the cutting time for the bodies has become acceptable as well. Strains on the lifting equipment may be further reduced by the body being turned into an upright position before being lifted through the splash zone.

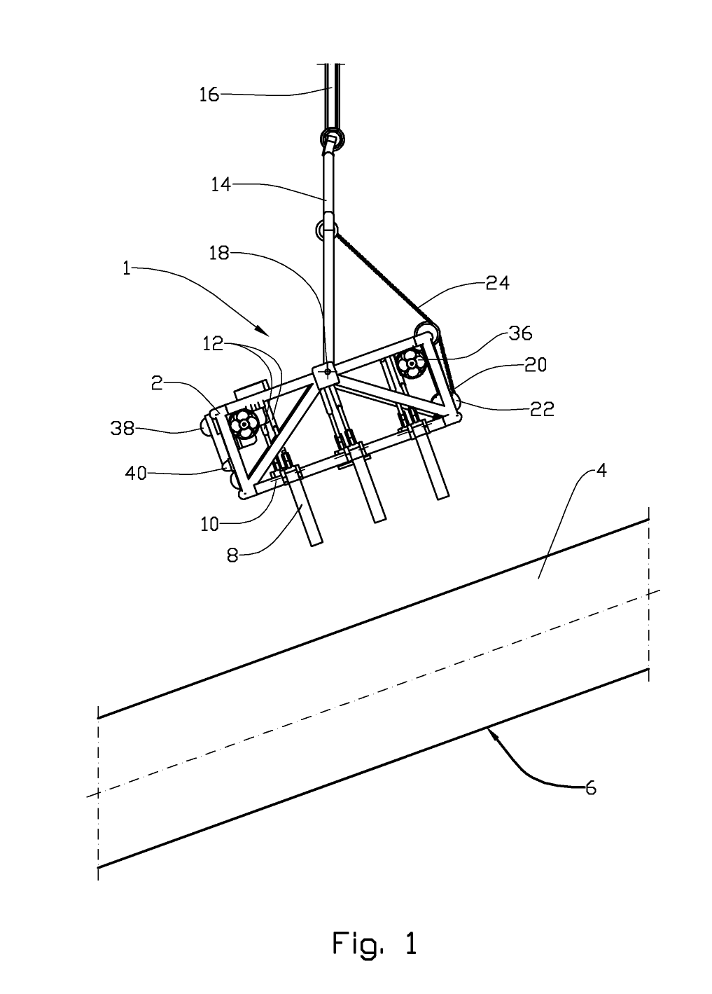

FIG. 1 generally illustrates a lifting beam 1 in the form of a frame structure 2 which is arranged to abut against an elongated body 4 belonging to a subsea structure 6. The lifting beam 1 is provided with a number of grippers 8 which are each rotatably connected to the lifting beam 1 around a first rotational axis 10. The grippers 8 are designed to grip around bodies of different shapes and cross-sectional dimensions. The grippers 8 may rotate to encircle the body 4 and/or connect the body 4 to the lifting beam 1.

A first actuator 12 may rotate each of the grippers 8 between an open, free position and a closed, gripping position. The first actuator 12 may be a hydraulic cylinder.

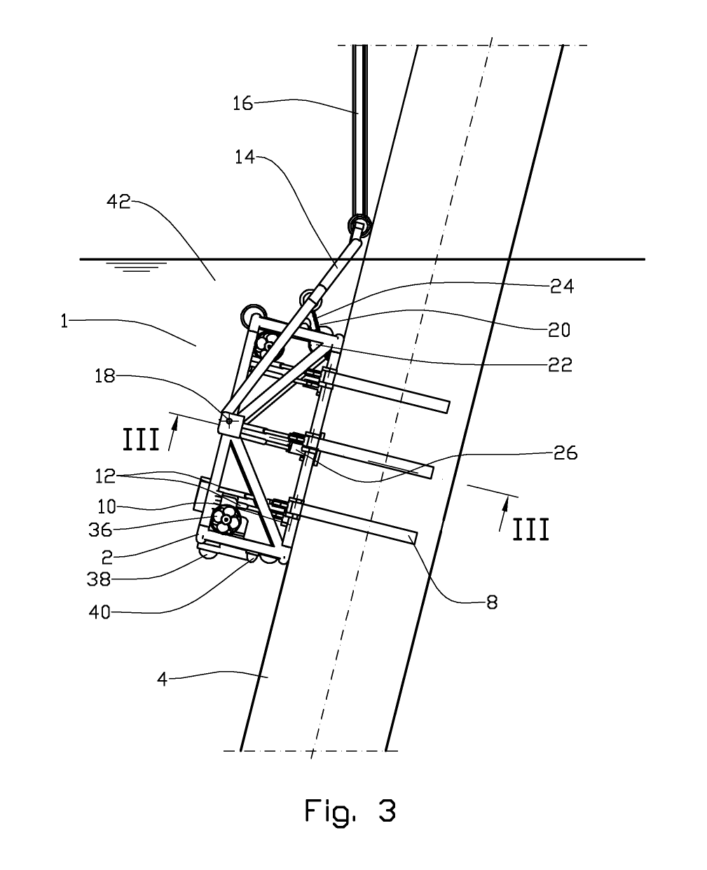

A bow-shaped lifting connector 14 is connected to a lifting device 16, and the bow-shaped lifting connector 14 is rotatably connected to the lifting beam 1 around a second rotational axis 18. For example, the bow-shaped lifting connector 14 may be rotatably connected to the frame structure 2. The lifting connector 14 is rotatable between a swung-out position, as shown in FIG. 1, and a swung-in position, as shown in FIG. 3. The lifting connector 14 may be substantially perpendicular to the body 4 when the lifting connector 14 is in the swung-out position. The lifting connector 14 may be substantially parallel to the body 4 when the lifting connector 14 is in the swung-out position.

A second actuator 20 rotates the lifting connector 14 between the swung-out position and the swung-in position. In this preferred exemplary embodiment, the second actuator 20 is formed by a winch 22 with a chain 24. For example, the winch may move the lifting connector 14 from the swung-out position to the swung-in position by increasing the amount of the chain 24 which is coiled on the winch 22, and the winch 22 may move the lifting connector 14 from the swung-in position to the swung-out position by decreasing the amount of the chain 24 which is coiled on the winch 22.

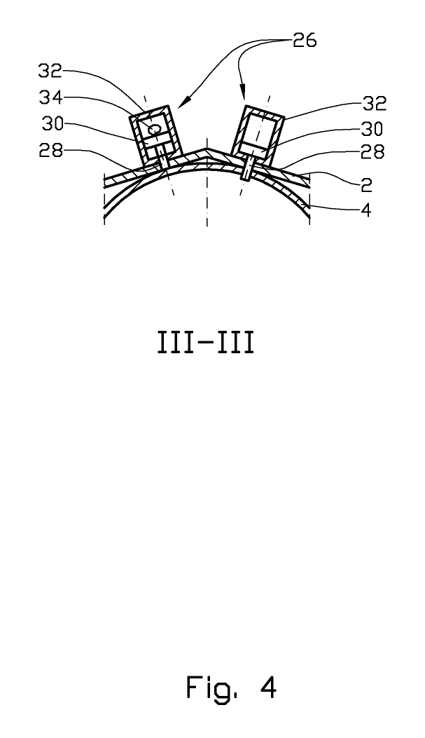

As shown in FIG. 4, a locking-pin mover 26 is connected to the lifting beam 1 in the frame structure 2. In this preferred exemplary embodiment, the locking-pin mover 26 includes a locking pin 28 which is connected to a piston 30. The piston 30 is in a cylinder 32 which is arranged to hold a pyrotechnical charge 34.

Before the pyrotechnical charge 34 is detonated, the locking pin 28 and the piston 30 are retracted as shown in the left part of FIG. 4. After the detonation, the locking pin 28 has penetrated the body 4, locking the locking pin 28 axially to the lifting beam 1 as shown in the right part of FIG. 4. The lifting beam 1 is provided with a thruster 36, a light source 38 and a camera 40. The thruster 36 may be a small propulsive device, such as a pumping device, a device with a propeller, and/or the like. The device according to the invention is used as explained in the general part of the specification, and the lifting beam 1 with the body 4 in an upright position is lifted through a splash zone 42. The splash zone 42 may be area above the spring high tide line that is splashed but not submerged by ocean water.

Various changes and modifications to the presently preferred embodiments described herein will be apparent to those skilled in the art. Such changes and modifications may be made without departing from the spirit and scope of the present invention and without diminishing its attendant advantages. Such changes and modifications are covered by the appended claims.

I claim:

1. A method of bringing an elongated body belonging to a subsea structure to the surface, the method comprising:
lowering a freely suspended lifting beam to the body;
pivoting the lifting beam until the lifting beam is substantially parallel to the body;
gripping the body with grippers;
after the body has been released from the subsea structure, turning the body with an actuator until the body is in an upright position; and
lifting the body through a splash zone to the surface.

2. The method of claim 1 further comprising:
locking the body, at least in the axial direction, to the lifting beam with a locking pin.

3. A lifting beam for bringing an elongated body belonging to a subsea structure to the surface wherein the lifting beam is arranged to be connected to a lifting device and further wherein the lifting beam is freely suspended, the lifting beam comprising:
actuator-operated grippers which are movable between an open, free position and a closed, gripping position; and
an actuator-operated lifting connector movable relative to the lifting beam.

4. The lifting beam of claim 3 wherein the grippers are rotatably connected to the lifting beam.

5. The lifting beam of claim 3 wherein the lifting connector is rotatable relative to the lifting beam.

6. The lifting beam of claim 3 wherein the lifting connector is displaceable relative to the lifting beam.

7. The lifting beam of claim 3 wherein the lifting beam further comprises:
at least one locking-pin mover.

8. The lifting beam of claim 3 wherein the lifting beam further comprises:
at least one thruster.

9. The lifting beam of claim 3 wherein the lifting beam further comprises:
at least one light source.

10. The lifting beam of claim 3 wherein the lifting beam further comprises:
at least one camera.
